(19) United States
(12) Patent Application Publication
(10) Pub. No.: US 2011/0061196 A1
(43) Pub. Date: Mar. 17, 2011

(54) Compression hinge

(76) Inventor: Timothy J. Cox, Charleston, SC (US)

(21) Appl. No.: 12/804,873

(22) Filed: Jul. 30, 2010

Related U.S. Application Data
(60) Provisional application No. 61/276,702, filed on Sep. 16, 2009.

(51) Int. Cl. E05D 11/02; E05D 11/04

(52) U.S. Cl. 16/274; 16/275

(57) ABSTRACT

A compression hinge is disclosed for hingedly supporting a metal structure, such as a door or hatch.

### RELATED APPLICATIONS

This application claims the benefit of U.S. Provisional Application No. 61/276,702 filed on Sep. 16, 2009.

### BACKGROUND OF THE INVENTION

1. Field of the Invention

This application discloses and claims embodiments generally related to hinges, and more particularly, to a compression hinge.

2. Description of the Related Art

Door hinges, and particularly, automobile door hinges are generally constructed of a pair of metal stampings each having flanges struck thereover, so as to provide four overlapped flanges. A hinge pin is fitted in aligned holes in the four overlapped flanges. Such configuration creates substantial friction between the respective moving parts, including corresponding wear, resulting in misaligned components, and doors which sag or fail to open and close properly.

In addition, conventional vehicle and vessel door hinges often become damaged and inoperable during vehicle/vessel accidents, thus preventing occupants from egressing the vehicle or vessel.

Accordingly, a long felt need has been realized for a hinge for a vehicle and/or vessel door adapted and configured to allow the door to remain openable in the event the motor vehicle and/or vessel, and particularly, the door and door frame elements, become damaged, thereby allowing vehicle and/or vessel occupants to egress and ingress from the vehicle and/or vessel. The development of the compression hinge fulfills this need.

This application presents claims and embodiments that fulfill a need or needs not yet satisfied by the products, inventions and methods previously or presently available. In particular, the claims and embodiments disclosed herein describe a compression hinge, the compression hinge comprising a pair of hinge blocks, a pair of ball bearings, and a hinge arm pivotally mounted between the pair of hinge blocks via the pair of ball bearings, wherein the compression hinge providing unanticipated and nonobvious combination of features distinguished from the devices, inventions and methods preexisting in the art. The applicant is unaware of any product, device, method, disclosure or reference that discloses the features of the claims and embodiments disclosed herein.

### SUMMARY OF THE INVENTION

In accordance with one embodiment of the present invention, a compression hinge is disclosed for hingedly supporting a door or a hatch, the compression hinge comprises a pair of hinge blocks between which a hinge arm is pivotally mounted via a pair of ball bearings. The pair of hinge blocks comprises a first hinge block and a second hinge block. The first and second hinge blocks are mounted, preferably, via welding, to a door/hatch frame or a door/hatch support.

The first and second hinge blocks each comprise a top side, a bottom side, a forward side, a rearward side, a left side, and a right side.

The right side of the first hinge block includes a concave recess being shaped and configured for receiving a first ball bearing therein. The rearward side of first hinge block includes a hole defined longitudinally therein for receiving a grease fitting.

The left side of the second hinge block includes a concave recess being shaped and configured for receiving a second ball bearing therein. The rearward side of second hinge block includes a hole defined longitudinally therein for receiving a grease fitting.

The hinge arm is defined as having an elongated body, the body comprising a front end opposing a rear end, a top side opposing a lower side, a left side, and a right side. The lower side comprises a recessed cavity configured to prevent the hinge arm from shearing in the event the compression hinge, and particularly the hinge arm thereof, undergoes deformation.

The left side of the body of the hinge arm includes a left concave recess defined therein. The left concave recess is shaped and configured for receiving the first ball bearing therein.

The right side of the body of the hinge arm includes a right concave recess defined therein. The right concave recess is shaped and configured for receiving the second ball bearing therein.

The hinge arm further comprises a hole defined longitudinally therein. The hole has a lower end which extends into a transverse bore, wherein the transverse bore being in fluid communication with the hole. The hole of hinge arm receives a grease fitting.

The concave recess of the first hinge block and the left concave recess of the left side of the body of the hinge arm jointly form a first socket into which the first ball bearing is compressionally received so as to pivotally mount the first hinge block to the hinge arm. The concave recess of the second hinge block and the right concave recess of the right side of the body of the hinge arm jointly form a second socket into which the second ball bearing is compressionally received so as to pivotally mount the second hinge block to the hinge arm.

Compression forces are applied simultaneously to the first hinge block and the second hinge block, respectively, via a compression jig, in order to facilitate pivotally secured mounting of the hinge arm between the first hinge block and the second hinge block. In order to control the swing of the door or hatch, the compression or compressive forces, which are applied simultaneously to the first hinge block and the second hinge block, must be less than the weight of the door or hatch. For example, in the event the door or hatch weighs 200 lbs., the compression forces applied simultaneously to the first and second hinge block, respectively, must be less than 200 lbs. of compressive force. The term “control”, as used herein, means to regulate or govern the speed and smoothness at which door or hatch swings. Thus, in the above example, where the door weighs 200 lbs. and the compression hinge is placed under a compression force of 198 lbs., the door is allowed to swing in a smooth and controlled manner.

The use of the present invention allows a vehicle and/or vessel door or hatch to remain in an operable condition, and thus openable in the event the door, hatch, and/or door frame elements become damaged.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of a compression hinge, shown from rear, above, and left side, according to the preferred embodiment of the present invention;

FIG. 2 is a perspective view of the compression hinge of the present invention, shown from rear, below, and right side according to the preferred embodiment thereof;

FIG. 3 is a perspective view of the compression hinge of the present invention, shown from front, below, and left side, according to the preferred embodiment of the present invention;

FIG. 4 is a right side perspective view of the compression hinge of the present invention, shown from below, according to the preferred embodiment of the present invention;

FIG. 5 is a top plan view of the compression hinge, according to the preferred embodiment of the present invention;

FIG. 6 is a cross-sectional view of a hinge arm taken along lines VI-VI of FIG. 5, according to the preferred embodiment;

FIG. 7 is a cross-sectional view of the compression hinge taken along lines VII-VII of FIG. 5, according to the preferred embodiment of the present invention;

FIG. 8 is a cross-sectional view of the compression hinge taken along lines VIII-VIII of FIG. 7, according to the preferred embodiment of the present invention; and

FIG. 9 is a perspective view of the present invention illustrated as a pair, and shown in-use.

### DESCRIPTION OF THE PREFERRED EMBODIMENT

### Detailed Description of the Figures

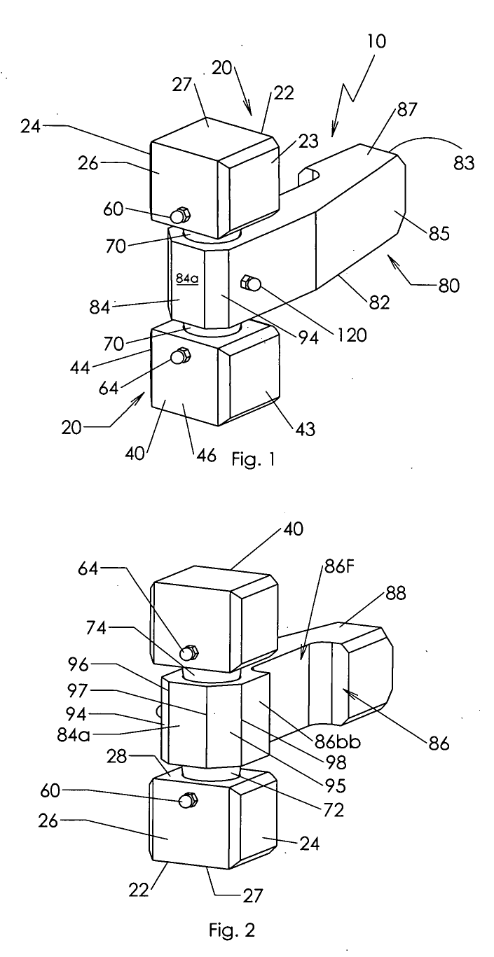

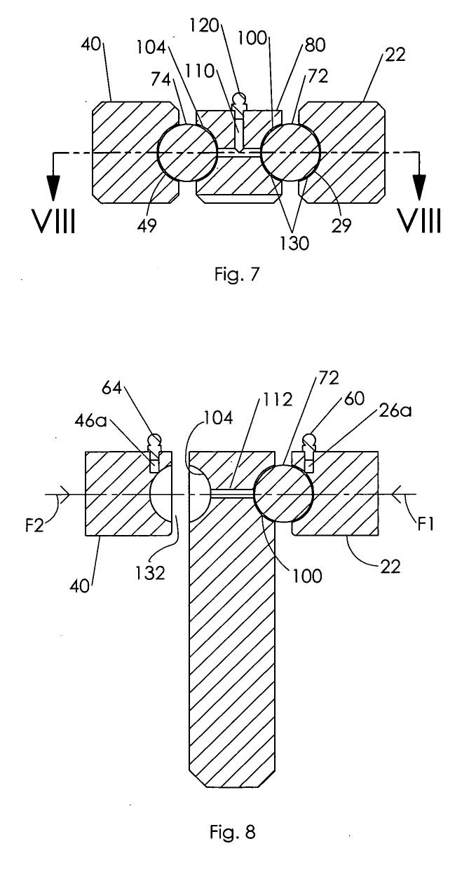

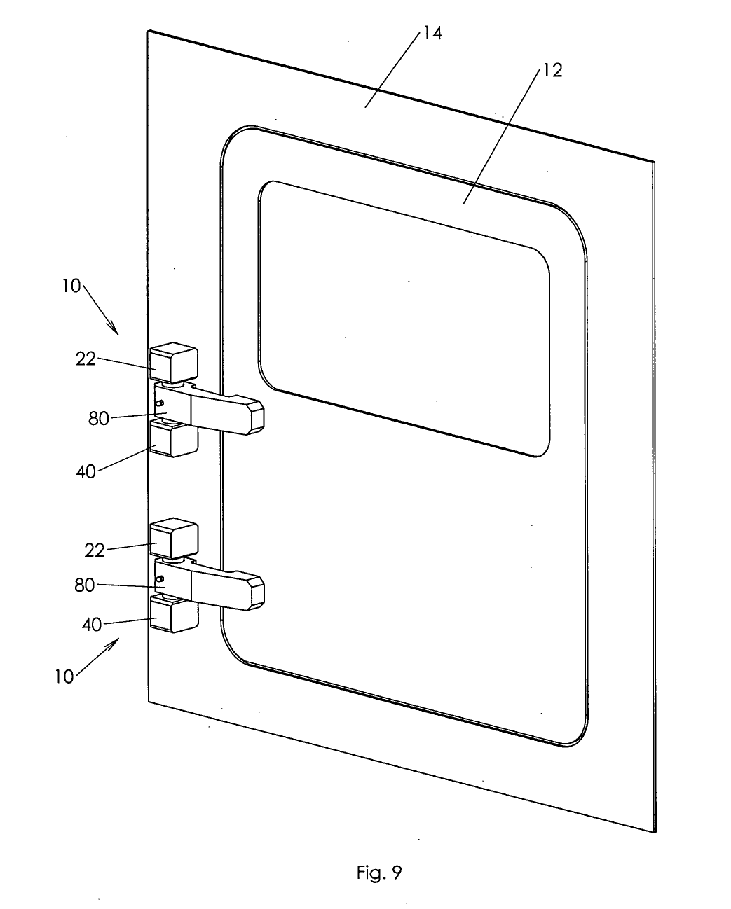

With reference to FIGS. 1-9, a compression hinge 10 is disclosed, according to one embodiment of the present invention, for hingedly supporting a door 12 or hatch of, e.g, a motor vehicle (not shown), the compression hinge 10 comprises a pair of hinge blocks 20 between which a hinge arm 80 is pivotally mounted via a pair of ball bearings 70. The hinge arm 80 is adapted and configured to pivot about a longitudinal axis Y. The pair of hinge blocks 20 comprises a first hinge block 22 and a second hinge block 40. The first hinge block 22 and the second hinge block 40 is each defined as being solid, and having a generally square configuration with six sides. While the first hinge block 22 and the second hinge block 40 preferably define a square shape, other geometric shapes are contemplated and within the scope and spirit of the present invention. Thus, the first hinge block 22 and the second hinge block 40 may alternatively each comprise geometric shapes which include, but are not limited to rectangular, oval, ovoid, triangular, trapezoidal, pentagonal, heptagonal, hexagonal, and octagonal.

The six sides defining the first hinge block 22 include a top side 23, a bottom side 24, a forward side 25, a rearward side 26, a left side 27, and a right side 28. The rearward side 26 integrally joins the top side 23 at first interface 30, wherein first interface 30 is defined as a first chamfer 31. The left side 27 integrally joins the top side 23 at second interface 32, wherein second interface 32 is defined as a second chamfer 33. The right side 28 integrally joins the top side 23 at third interface 34, wherein third interface 34 is defined as a third chamfer 35. The chamfers 31, 33, and 35 facilitate welding of the first hinge block 22 to a door frame 14/hatch frame or door support/hatch support.

The right side 28 of first hinge block 22 includes a concave recess 29 defined centrally therein, the concave recess 29 being shaped and configured for receiving a first ball bearing 72 therein.

The rearward side 26 of first hinge block 22 includes a hole 26a defined longitudinally therein, proximal to the right side 28 and oriented parallel therewith, the hole 26a receives a grease fitting 60 being suitably mounted therein. The hole 26a extends longitudinally to a depth so as to be in fluid communication with an inner circumferential surface of the concave recess 29. The hole 26a is adapted to facilitate lubrication of a first socket 130 (to be described later in greater detail).

The six sides defining the second hinge block 40 include a top side 43, a bottom side 44, a forward side 45, a rearward side 46, a right side 47, and a left side 48. The rearward side 46 integrally joins the top side 43 at first interface 50, wherein first interface 50 is defined as a first chamfer 51. The right side 47 integrally joins the top side 43 at second interface 52, wherein second interface 52 is defined as a second chamfer 53. The left side 48 integrally joins the top side 43 at third interface 54, wherein third interface 54 is defined as a third chamfer 55. The chamfers 51, 53, and 55 facilitate welding of the second hinge block 40 to a door/hatch frame or door/hatch support.

The left side 48 of second hinge block 40 includes a concave recess 49 defined centrally therein, the concave recess 49 being shaped and configured for receiving a second ball bearing 74 therein.

The rearward side 46 of second hinge block 40 includes a hole 46a defined longitudinally therein, proximal to the left side 48 and oriented parallel therewith, the hole 46a receives a grease fitting 64 being suitably mounted therein. The hole 46a extends longitudinally to a depth so as to be in fluid communication with an inner circumferential surface of the concave recess 49. The hole 46a is adapted to facilitate lubrication of a second socket 132 (to be described later in greater detail).

The hinge arm 80 is defined as being solid and having an elongated body 82, the body 82 comprising a front end 83 opposing a rear end 84. The body 82 further comprises a top side 85 opposing a bottom side 86, a left side 87, and a right side 88. The top side 85 includes first segment 85a and a second segment 85b, the first segment 85a extending longitudinally from the rear end 84 to a margin 85c from which the second segment 85c integrally slopes downward at an angle of approximately 168°.

The front end 83 is defined as having a flat surface 83a, the flat surface 83a being flanked by a left interface 90 and a right interface 91, wherein the left interface 90 integrally joining the front end 83 at margin 90a so as to form an obtuse angle, and the right interface 91 integrally joining the front end 83 at margin 91 a so as to form an obtuse angle.

The bottom side 86 defines a mid portion 86c integrally joining a first portion 86a and a second portion 86b, wherein the first portion 86a includes a flat surface 86aa having a perimeter from which a chamfered sidewall 86ab upwardly depends angularly therefrom and integrally joining left side 87, right side 88, front end 83, left interface 90, and right interface 91. The chamfered sidewall 86ab facilitates welding of the hinge arm 80 to a door 12 or hatch.

The mid portion 86c defines a planar surface 86d terminating at opposing first and second lateral incurvate ends 86e and 86ee, the first and second lateral incurvate ends 86e and 86ee downwardly depending from the planar surface 86d so as to form a recessed cavity 86f. Significantly, the first and second lateral incurvate ends 86e and 86ee, and the recessed cavity 86f are configured to prevent the hinge arm 80 from shearing or binding in the event the compression hinge 10, and particularly the hinge arm 80 thereof, undergoes deformation or extreme deformation. The term “binding”, as used herein, means to hamper or restrain the normal operation or action.

In addition, in the event compression hinge 10 undergoes deformation or extreme deformation, the first and second ball bearings 72 and 74 nevertheless allow the hinge arm 80 to pivot thereabout, thereby ensuring a vehicle door 12 or hatch, or vessel door/hatch is openable.

The second portion 86b includes a flat surface 86bb integrally joining the second lateral incurvate end 86ee at interface 86g.

The rear end 84 is defined as having a flat surface 84a, the flat surface 84a being flanked by an upper interface 94 and a lower interface 95, wherein the upper interface 94 integrally joining the flat surface 84a of rear end 84 at margin 96 so as to form an obtuse angle, and the lower interface 95 integrally joining the flat surface 84a of rear end 84 at margin 97 so as to form an obtuse angle. The lower interface 95 integrally joins the flat surface 86bb of second portion 86b of bottom side 86 at margin 98. The upper interface 94 and the lower interface 95 are configured to provide clearance by the rear end 84 of hinge arm 80 with the door frame 14/hatch frame or door support/hatch support when opening the door 12 or hatch thereof.

The left side 87 of the body 82 of the hinge arm 80 includes a left concave recess 100 defined therein, adjacent the rear end 84 of the body 82. The left concave recess 100 being shaped and configured for receiving the first ball bearing 72 therein.

The right side 88 of the body 82 of the hinge arm 80 includes a right concave recess 104 defined therein, adjacent the rear end 84 of the body 82. The right concave recess 104 being shaped and configured for receiving the second ball bearing 74 therein.

The hinge arm 80 further comprises a hole 110 defined longitudinally therein, adjacent the upper interface 94 which flanks the flat surface 84a of the rear end 84 of the elongated body 82 of hinge arm 80. The hole 110 has a lower end which extends into a transverse bore 112, the transverse bore 112 being in fluid communication with the hole 110. The transverse bore 112 extends horizontally so as to be in fluid communication with an inner circumferential surface of each the left concave recess 100 and the right concave recess 104. The hole 110 receives a grease fitting 120 being suitably mounted therein.

The concave recess 29 of first hinge block 22 and the left concave recess 100 of the left side 87 of the body 82 of the hinge arm 80 jointly form a first socket 130 into which the first ball bearing 72 is compressionally received so as to pivotally mount the first hinge block 22 to hinge arm 80. Likewise, the concave recess 49 of second hinge block 40 and the right concave recess 104 of the right side 88 of the body 82 of the hinge arm 80 jointly form a second socket 132 into which the second ball bearing 74 is compressionally received so as to pivotally mount the second hinge block 40 to hinge arm 80.

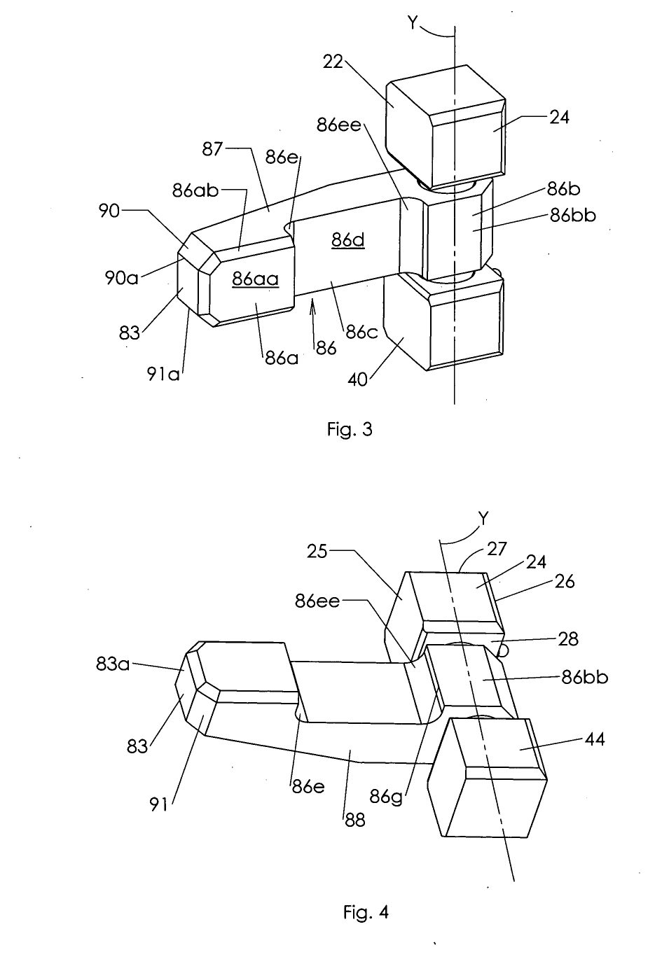

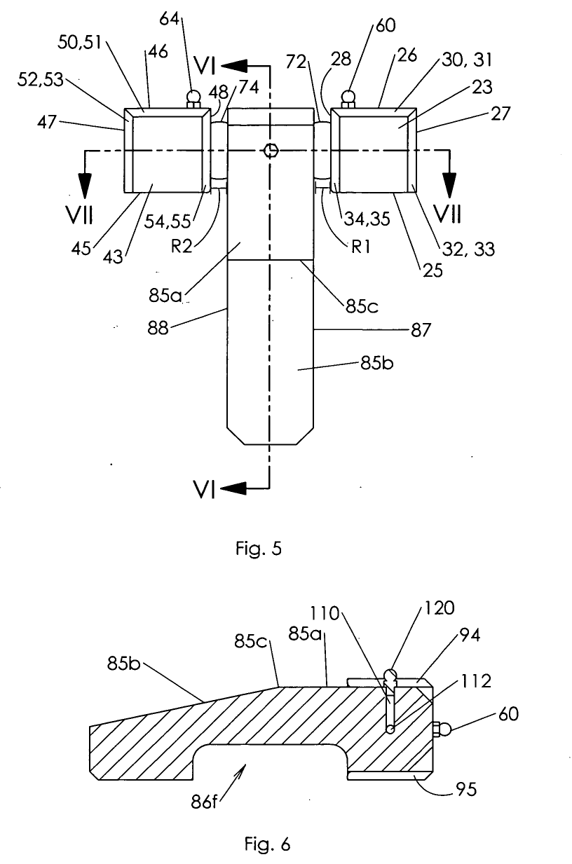

Pivotal mounting by the first hinge block 22 to the hinge arm 80 forms a first variable radius, indicated by R1 in FIG. 5. The first variable radius R1 is more specifically defined as the distance from the left side 87 of the body 82 of hinge arm 80 to the right side 28 of the first hinge block 22. The radius R1 is variable because should the hinge arm 80 undergo deformation in a longitudinal direction (with respect to longitudinal axis Y illustrated in FIG. 3), the radius R1 increases where hinge arm 80 undergoes deformation in a downward, longitudinal direction, and the radius R1 decreases where the hinge arm 80 undergoes deformation in an upward, longitudinal direction.

Pivotal mounting by the second hinge block 40 to the hinge arm 80 forms a second variable radius, indicated by R2 in FIG. 5. The second variable radius R2 is more specifically as the distance from the right side 88 of the body 82 of hinge arm 80 to the left side 48 of the second hinge block 40. Radius R2 is variable because should the hinge arm 80 undergo deformation in a longitudinal direction (with respect to longitudinal axis Y illustrated in FIG. 3), the second variable radius R2 decreases where hinge arm 80 undergoes deformation in a downward, longitudinal direction, and the second variable radius R2 increases where the hinge arm 80 undergoes deformation in an upward, longitudinal direction. The first and second variable radii R1 and R2 further aid in preventing the hinge arm 80 from shearing or binding in the event hinge arm undergoes deformation or extreme deformation, and thereby allowing the hinge arm 80 to pivot about longitudinal axis Y.

Compression forces, as indicated by force direction arrows F1 and F2, are applied simultaneously to the first hinge block 22 and the second hinge block 40, respectively, via a compression jig, in order to facilitate pivotally secured mounting by the hinge arm 80 to and between the first hinge block 22 and the second hinge block 40. Preferably, the compression hinge 10 is mounted to a door frame 14/hatch frame or door support/hatch support during the course of applying compression forces F1 and F2 to first hinge block 22 and second hinge block 40, respectively.

In order to control the swing of the door 12 or hatch, the compression or compressive forces, which are applied simultaneously to the first hinge block 22 and the second hinge block 40, must be less than the weight of the door 12 or hatch. For example, in the event the door 12 or hatch weighs 200 lbs., the compression forces applied simultaneously to the first and second hinge block 22 and 40, respectively, must be less than 200 lbs. of compressive force. The term “control”, as used herein, means to regulate or govern the speed and smoothness at which door 12 or hatch swings. Thus, in the above example, where the door 12 weighs 200 lbs. and the compression hinge 10 is placed under a compression force of 198 lbs., the door 12 is allowed to swing in a smooth and controlled manner.

While the hinge arm 80 preferably defines an elongated body 82 as described hereinabove, other geometric shapes are contemplated and within the scope and spirit of the present invention. Thus, the hinge arm 80 may alternatively comprise geometric shapes which include, but are not limited to rectangular, oval, ovoid, triangular, trapezoidal, pentagonal, heptagonal, hexagonal, and octagonal.

The compression hinge 10 is constructed of a metal material.

It is envisioned that the various embodiments, as separately disclosed, are interchangeable in various aspects, so that elements of one embodiment may be incorporated into one or more of the other embodiments, and that specific positioning of individual elements may necessitate other arrangements not specifically disclosed to accommodate performance requirements or spatial considerations.

It is to be understood that the embodiments and claims are not limited in its application to the details of construction and arrangement of the components set forth in the description and illustrated in the drawings. Rather, the description and the drawings provide examples of the embodiments envisioned, but the claims are limited to the specific embodiments. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

Therefore, the foregoing description is included to illustrate the operation of the preferred embodiment and is not meant to limit the scope of the invention. As one can envision, an individual skilled in the relevant art, in conjunction with the present teachings, would be capable of incorporating many minor modifications that are anticipated within this disclosure. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be broadly limited only by the following Claims.

What is claimed is:

1. A compression hinge, the compression hinge comprising:
a pair of hinge blocks;
a pair of ball bearings; and
a hinge arm pivotally mounted between the pair of hinge blocks via the pair of ball bearings.

2. The compression hinge of claim 1, wherein the pair of hinge blocks comprises a first hinge block and a second hinge block, the first hinge block is solid, and the second hinge block is solid.

3. The compression hinge of claim 2, wherein the first hinge block includes a forward side, a rearward side, a left side, a right side, a top side, and a bottom side, the rearward side integrally joins the top side at a first interface, wherein the first interface is defined as a first chamfer, the left side integrally joins the top side at a second interface, wherein the second interface is defined as a second chamfer, the right side integrally joins the top side at a third interface, wherein the third interface is defined as a third chamfer, the first chamfer, the second chamfer, and third chamfer facilitate welding of the first hinge block to a frame or a support structure.

4. The compression hinge of claim 3, wherein the right side of the first hinge block includes a concave recess defined centrally therein, the concave recess being shaped and configured for receiving a first ball bearing therein.

5. The compression hinge of claim 4, wherein the first hinge block includes a hole defined longitudinally therein, the hole receives a grease fitting being suitably mounted therein, the hole extends longitudinally to a depth so as to be in fluid communication with an inner circumferential surface of the concave recess.

6. The compression hinge of claim 2, wherein the second hinge block includes a forward side, a rearward side, a left side, a right side, a top side, and a bottom side, the rearward side integrally joins the top side at a first interface, wherein the first interface is defined as a first chamfer, the right side integrally joins the top side at a second interface, wherein the second interface is defined as a second chamfer, the left side integrally joins the top side at a third interface, wherein the third interface is defined as a third chamfer, the first chamfer, the second chamfer, and the third chamfer facilitate welding of the second hinge block to a frame or a support structure.

7. The compression hinge of claim 6, wherein the left side of the second hinge block includes a concave recess defined centrally therein, the concave recess being shaped and configured for receiving a second ball bearing therein.

8. The compression hinge of claim 7, wherein the second hinge block includes a hole defined longitudinally therein, the hole receives a grease fitting being suitably mounted therein, the hole extends longitudinally to a depth so as to be in fluid communication with an inner circumferential surface of the concave recess.

9. The compression hinge of claim 1, wherein the hinge arm is defined as being solid and having an elongated body, the body comprising a front end opposing a rear end, a top side opposing a bottom side, a left side, and a right side.

10. The compression hinge of claim 9, wherein the top side includes a first segment and a second segment.

11. The compression hinge of claim 9, wherein the front end is defined as having a flat surface, the flat surface being flanked by a left interface and a right interface, wherein the left interface integrally joining the front end at a first margin so as to form an obtuse angle, and the right interface integrally joining the front end at a second margin so as to form an obtuse angle.

12. The compression hinge of claim 9, wherein the bottom side defines a first portion, a second portion, and a mid portion, the first portion and the second portion are integrally adjoined by the mid portion.

13. The compression hinge of claim 12, wherein the first portion includes a flat surface having a perimeter from which a chamfered sidewall upwardly depends angularly therefrom and integrally joins a left side, a right side and a front end of the hinge arm, and the chamfered sidewall further integrally joining a left interface and a right interface of the front end of the hinge arm, and wherein the chamfered sidewall facilitates welding of the hinge arm to a door or a similar structure.

14. The compression hinge of claim 12, wherein the mid portion defines a planar surface terminating at a first lateral incurvate end and a second lateral incurvate end, the first lateral incurvate end opposing the second lateral incurvate end, the first lateral incurvate end and the second lateral incurvate end each downwardly depend from the planar surface so as to form a recessed cavity, wherein the first lateral incurvate end, the second lateral incurvate end, and the recessed cavity are conjunctively configured to prevent the hinge arm from shearing in the event the compression hinge or the hinge arm thereof, undergoes deformation.

15. The compression hinge of claim 12, wherein the second portion includes a flat surface integrally joining a second lateral incurvate end of the mid portion at an interface.

16. The compression hinge of claim 9, wherein the rear end of the body is defined as having a flat surface, the flat surface being flanked by an upper interface and a lower interface, wherein the upper interface integrally joining the flat surface of the rear end at a first margin so as to form an obtuse angle, and the lower interface integrally joining the flat surface of the rear end at a second margin so as to form an obtuse angle, the lower interface integrally joins a flat surface of a second portion of the bottom side at a third margin, wherein the upper interface and the lower interface are configured to provide clearance by the rear end of the hinge arm with a door or hatch frame or door or hatch support when opening the door or the hatch thereof.

17. The compression hinge of claim 9, wherein the left side of the body comprises a left concave recess defined therein, adjacent the rear end of the body, the left concave recess being shaped and configured for receiving the first ball bearing therein, and wherein the right side of the body comprises a right concave recess defined therein, adjacent the rear end of the body, the right concave recess being shaped and configured for receiving the second ball bearing therein.

18. The compression hinge of claim 16, wherein the body further comprises a hole defined longitudinally in the top side thereof, adjacent the upper interface which flanks the flat surface of the rear end of the body of hinge arm, the hole has a lower end which extends into a transverse bore, the transverse bore being in fluid communication with the hole, the transverse bore extends horizontally so as to be in fluid communication with an inner circumferential surface of each a left concave recess of the left side of the body and a right concave recess of the right side of the body, and wherein the hole receives a grease fitting being suitably mounted therein.

19. The compression hinge of claim 17, wherein the left concave recess of the left side of the body of the hinge arm and a concave recess of a first hinge block of the pair of hinge blocks jointly form a first socket into which the first ball bearing of the pair of ball bearings is compressionally received so as to pivotally mount the first hinge block to the hinge arm, and wherein the right concave recess of the right side of the body of the hinge arm and a concave recess of a second hinge block of the pair of hinge blocks jointly form a second socket into which the second ball bearing of the pair of ball bearings is compressionally received so as to pivotally mount the second hinge block to the hinge arm.

20. The compression hinge of claim 1, wherein the pair of ball bearings comprise a first ball bearing and a second ball bearing, the first ball bearing and the second ball bearing pivotally mounting the hinge arm between the pair of hinge blocks, respectively, in a manner so as to allow the hinge arm to pivot about the first ball bearing and the second ball bearing along a longitudinal axis in the event the hinge arm and/or the pair of hinge blocks undergo deformation.
